(19) United States
(12) Patent Application Publication
(10) Pub. No.: US 2025/0256720 A1
(43) Pub. Date: Aug. 14, 2025

(54) DRIVING ASSISTANCE DEVICE AND DRIVING ASSISTANCE METHOD

(71) Applicant: TOYOTA JIDOSHA KABUSHIKI KAISHA, Aichi-ken (JP)

(72) Inventor: Yota KATO, Numazu-shi (JP)

(21) Appl. No.: 19/047,637

(22) Filed: Feb. 7, 2025

(30) Foreign Application Priority Data
Feb. 14, 2024 (JP) 2024-020260

(51) Int. Cl. B60W 30/16; B60W 60/00

(52) U.S. Cl. CPC B60W 30/16; B60W 60/001; B60W 2554/4041; B60W 2554/802; B60W 2710/20; B60W 2720/106

(57) ABSTRACT

A driving assistance device can execute driving assistance of a vehicle at a first and second assistance levels. The device is configured to: detect an inter-vehicle distance between the vehicle and a preceding vehicle; and when a switching condition to an arbitrary assistance level is satisfied, switch an assistance level in the driving assistance to an assistance level in which the switching condition is satisfied. The first assistance level is an assistance level at which acceleration and deceleration is automatically performed but steering is not automatically performed. The second assistance level is an assistance level at which acceleration, deceleration and steering are automatically performed. The switching condition to each assistance level 10 includes that an inter-vehicle distance is greater than a reference distance. A reference distance in the switching condition to the second assistance level is longer than a reference distance in the switching condition to the first assistance level.

### FIELD

The present disclosure relates to a driving assistance device and a driving assistance method.

### BACKGROUND

Conventionally, a driving assistance device that performs a driving assistance of a driver has been known (JP 2022-155463 A, JP H11-342766 A, etc.). In particular, in the device described in JP 2022-155463 A, the driving assistance control and the autonomous travel control can be executed, and the inter-vehicle distance based on the driving assistance control is set narrower than the inter-vehicle distance based on the autonomous travel control. In addition, in the control described in JP 2022-155463 A, when shifting from the driving assistance control to the autonomous travel control, after the inter-vehicle distance is changed, the travel control status is switched from the driving assistance control to the autonomous travel control.

In the device described in JP 2022-155463 A, switching of the travel control status from the driving assistance control to the autonomous travel control is performed after the inter-vehicle distance is changed. On the other hand, in the device described in JP 2022-155463 A, the driving assistance control can be executed at different assistance levels, but the change of the assistance level is executed independently of the inter-vehicle distance.

However, since the driver's response tends to be delayed more in an emergency as the assistance level is higher, if the change of the assistance level is executed independently of the inter-vehicle distance, there is a possibility that the driver cannot respond suddenly in an emergency.

### SUMMARY

In view of the above problems, an object of the present disclosure is to suppress a delay in response to a driver in an emergency when a assistance level is changed.

The gist of the present disclosure is as follows.
(1) A driving assistance device capable of executing driving assistance of a vehicle at a first assistance level and a second assistance level, which have different degrees of contribution to driving of a driver, comprising:
   an inter-vehicle distance detection unit for detecting an inter-vehicle distance between the vehicle and a preceding vehicle; and
   an assistance level switching unit for switching, when a switching condition to an arbitrary assistance level is satisfied, an assistance level in the driving assistance to an assistance level in which the switching condition is satisfied, wherein
   the first assistance level is an assistance level at which acceleration and deceleration of the vehicle is automatically performed but steering of the vehicle is not automatically performed.
   the second assistance level is an assistance level at which acceleration and deceleration and steering of the vehicle are automatically performed,
   the switching condition to each assistance level includes that an inter-vehicle distance is equal to or greater than a reference distance, and
   a reference distance in the switching condition to the second assistance level is longer than a reference distance in the switching condition to the first assistance level.
(2) The driving assistance device according to aspect (1), wherein
   the vehicle can also perform driving assistance of the vehicle at a third assistance level, in addition to the first assistance level and the second assistance level,
   in the second assistance level, the driver of the vehicle needs to visually recognize the front of the vehicle while the vehicle is automatically accelerated/decelerated and steered.
   the third assistance level is an assistance level at which acceleration and deceleration and steering of the vehicle are automatically performed, while the driver of the vehicle does not required to visually recognize a front thereof, and
   a reference distance in the switching condition to the third assistance level is longer than the reference distance in the switching condition to the second assistance level.
(3) The driving assistance device according to aspect (1) or (2), further comprising
   a driving control unit for controlling an operation of the vehicle, wherein
   the driving control unit controls the driving of the vehicle so that the inter-vehicle distance becomes longer when an increase in the assistance level is requested when the vehicle is being driven in the first assistance level or the second assistance level.
(4) The driving assistance device according to aspect (1) or (2), wherein the assistance level switching unit switches the assistance level to an assistance level which can be started based on the inter-vehicle distance, when the driving assistance at the highest assistance level is requested when the driving assistance is not executed.
(5) A driving assistance method for executing driving assistance of a vehicle at a first assistance level and a second assistance level, which have different degrees of contribution to driving of a driver, comprising:
   detecting an inter-vehicle distance between the vehicle and the preceding vehicle; and
   when a switching condition to an arbitrary assistance level is satisfied, switching an assistance level in the driving assistance to an assistance level in which the switching condition is satisfied, wherein
   the first assistance level is a assistance level at which acceleration and deceleration of the vehicle is automatically performed but steering of the vehicle is not automatically performed,
   the second assistance level is a assistance level at which acceleration and deceleration and steering of the vehicle are automatically performed,
   the switching condition to each assistance level includes that an inter-vehicle distance is equal to or greater than a reference distance, and
   a reference distance in a switching condition to the second assistance level is longer than a reference distance in the switching condition to the first assistance level.

### BRIEF DESCRIPTION OF DRAWINGS

FIG. 1 is a schematic block diagram illustrating a configuration of a driving assistance system.

FIG. 2 is a functional diagram of a processor of an ECU.

FIG. 3 is a diagram illustrating a state of vehicles traveling in one lane.

FIG. 4 is a flowchart illustrating a flow of assistance level setting processing for setting a assistance level.

FIG. 5 is a flowchart illustrating a flow of driving assistance processing for performing driving assistance based on the set assistance level.

### DESCRIPTION OF EMBODIMENTS

Hereinafter, an embodiment will be described in detail with reference to the drawings. In the following description, the same reference numerals are given to the same components.

### <Configuration of Vehicle Control System>

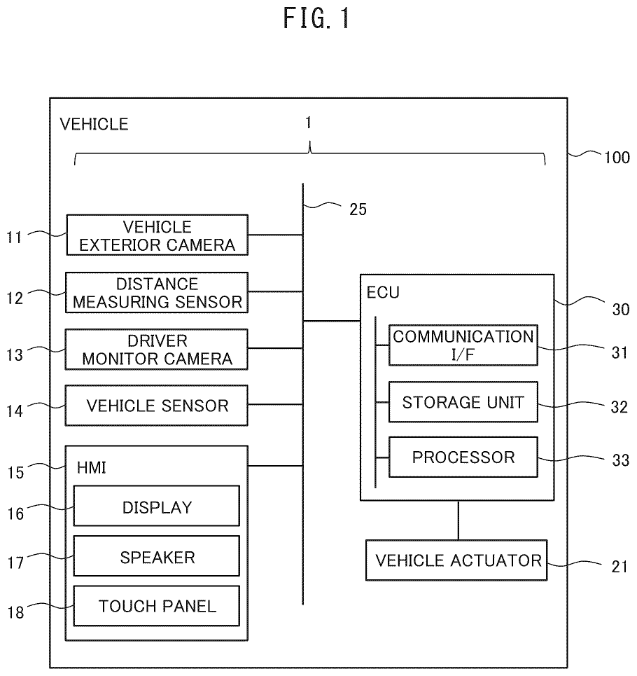

Referring to FIGS. 1 to 3, a configuration of a driving assistance system 1 including a driving assistance device according to an embodiment will be described. The driving assistance device may execute driving assistance of a vehicle 100 at a plurality of assistance levels having different degrees of contribution to driving of a driver. FIG. 1 is a schematic block diagram illustrating a configuration of the driving assistance system 1.

The driving assistance system 1 is mounted on the vehicle 100 and executes driving assistance of the vehicle 100 at a plurality of assistance levels having different degrees of contribution to driving of the driver. As illustrated in FIG. 1, in the present embodiment, the driving assistance system 1 includes a vehicle exterior camera 11, a distance measuring sensor 12, a driver monitor camera 13, a vehicle sensor 14, a human machine interface (HMI) 15, a vehicle actuator 21, and an electronic control unit (hereinafter, referred to as “ECU”) 30. The vehicle exterior camera 11, the distance measuring sensor 12, the driver monitor camera 13, the vehicle sensor 14, the HMI 15, and the ECU 30 are communicably connected via, for example, the in-vehicle network 25. The in-vehicle network 25 is, for example, a network conforming to a standard such as CAN (Controller Area Network). Further, the ECU 30 is connected to the vehicle actuator 21 via signal lines.

The vehicle exterior camera 11 is a device that captures an image of surroundings of the vehicle. In the present embodiment, the vehicle exterior camera 11 captures an image of the front of the vehicle 100. The vehicle exterior camera 11 is, for example, a CMOS (Complementary Metal-Oxide-Semiconductor) camera or a CCD (Charge-Coupled Device) camera, that is sensitive to visible-light. In the present embodiment, the vehicle exterior camera 11 is mounted inside of the vehicle 100, for example, so as to face the front of the vehicle 100. The vehicle exterior camera 11 captures an image of a front area of the vehicle 100 at every predetermined imaging intervals, and generates an image in which the front region is captured. Each time an image is generated, the vehicle exterior camera 11 outputs the generated image to the ECU 30 via the in-vehicle network 25.

The distance measuring sensor 12 is a sensor that measures a distance to an object existing around the vehicle 100. In the present embodiment, the distance measuring sensor 12 measures a distance to an object existing in front of the vehicle 100. In particular, in the present embodiment, the distance measuring sensor 12 can measure the distance to the preceding vehicle of the vehicle 100. The distance measuring sensor 12 is, for example, a radar such as a millimeter-wave radar or a LIDAR. The distance measuring sensor 12 outputs the measured distance to the surrounding object to the ECU 30 at every predetermined intervals via the in-vehicle network 25.

The driver monitor camera 13 is an apparatus that captures an image of a face of the driver. In the present embodiment, the driver monitor camera 13 is provided at an upper portion of the steering column and is arranged toward the driver so as to be able to capture an image of the driver, specifically, the face and a part of the upper body of the driver. The driver monitor camera 13 includes a camera and a floodlight. For example, the camera may be a CMOS camera or a CCD camera, and the floodlight may be a LED (light-emitting diode). In addition, the floodlight is preferably in a near-infrared LED so that the image of the driver's face can be captured without causing discomfort to the driver even at low illuminance, such as at night, and the camera is also preferably capable of detecting near-infrared rays. The driver monitor camera 13 outputs images captured at every predetermined intervals to the ECU 30 via the in-vehicle network 25.

The vehicle sensor 14 is a sensor that detects a state of the vehicle 100. The vehicle sensor 14 detects a traveling state and an operation state of the vehicle 100. The vehicle sensor 14 includes, for example, a speed sensor that detects the speed of the vehicle 100, an acceleration sensor that detects the acceleration of the vehicle 100, and the like, as sensors that detect the traveling state of the vehicle 100. In addition, the vehicle sensor 14 includes, for example, a self-position sensor (for example, a GPS sensor) that detects the self-position of the vehicle 100, as a sensor that detects the traveling condition of the vehicle 100. Further, the vehicle sensor 14 includes, for example, a steering wheel grip sensor that detects whether or not the driver grips a steering wheel (or touches the steering wheel), as a sensor that detects an operation state of the vehicle 100. The vehicle sensor 14 outputs a detection result to the ECU 30 at every predetermined intervals via the in-vehicle network 25.

The HMI 15 is an interface for inputting and outputting information between the driver or the occupant and the driving assistance system 1. The HMI 15 includes an information providing device for providing various types of information to a driver or an occupant, and an input device for the driver or the occupant to perform an input operation.

Specifically, the HMI 15 includes a display 16 for displaying character information or picture information as the information providing device. The display 16 is an example of a display device that displays an image. The display 16 is any type of display device such as a liquid crystal display or an organic EL display. The display 16 is arranged so that at least the driver can check the screen. Accordingly, the display 16 is disposed, for example, on an instrument panel, a meter panel, or the like of the vehicle 100. The display 16 receives an image signal from the ECU 30 via the in-vehicle network 25, and displays an image in accordance with the image signal. It should be noted that the vehicle 100 may include another type of display device such as a head-up display as the information providing device.

The HMI 15 includes a speaker 17 as the information providing device. The speaker 17 is an example of a device that outputs sound. The speaker 17 receives an audio signal from the ECU 30 via the in-vehicle network 25, and outputs sounds in accordance with the audio signal. The HMI 15 may include, as the information providing device, a device, other than the display 16 and the speaker 17, that provides various kinds of information to a driver or occupant (for example, a vibrating device).

In addition, the HMI 15 includes a touch panel 18 as the input device. The touch panel 18 is an example of a device in which an input is performed by a driver or a passenger touching the device. The touch panel 18 outputs an operation signal to the ECU 30 via the in-vehicle network 25 when the driver or the occupant performs an operation by touching. It should be noted that the HMI 15 may include, as the input device, a device, other than the touch panel 18, for the driver or the occupant to perform the input operation (for example, a button, a switch, or the like).

The vehicle actuator 21 is an actuator used to control the operation of the vehicle 100. Specifically, the vehicle actuator 21 includes, for example, a drive actuator for controlling an internal combustion engine or an electric motor for driving the vehicle 100, a braking actuator for controlling a brake for braking the vehicle 100, and a steering actuator for controlling steering of the vehicle 100. The vehicle actuator 21 controls acceleration, braking, and steering of the vehicle 100 in accordance with a control signal transmitted from the ECU 30 via a signal line.

### <Configuration of Driving Assistance Device>

The ECU 30 functions as a driving assistance device that executes driving assistance of the vehicles 100 at a plurality of different assistance levels. Specifically, in the present embodiment, driving assistance is executed at three assistance levels: a first assistance level, a second assistance level, and a third assistance level.

The first assistance level is a assistance level at which acceleration/deceleration of the vehicle 100 is automatically performed, but steering of the vehicle 100 is not automatically performed, and corresponds to, for example, level 1 of driving automation defined in SAE (Society of Automotive Engineers). Therefore, at the first assistance level, the internal combustion engine or the electric motor and the brake are controlled by the drive actuator and the brake actuator of the vehicle actuator 21. However, at the first assistance level, the steering actuator of the vehicle actuator 21 is not controlled. The drive actuator and the braking actuator are controlled so that the vehicle 100 travels at a preset speed when the preceding vehicle is not present, and are controlled so that the inter-vehicle distance to the preceding vehicle becomes a predetermined first reference distance when the preceding vehicle is present.

The second assistance level is an assistance level in which both acceleration and deceleration and steering of the vehicle 100 are automatically performed, but the driver is required to visually recognize the front, and corresponds to, for example, level 2 of driving automation defined in SAE. Therefore, at the second assistance level, the internal combustion engine or the electric motor and the brake are controlled by the vehicle actuator and the brake actuator, and the steering is controlled by the steering actuator. Even at the second assistance level, the drive actuator and the braking actuator are controlled in the same manner as the first assistance level. However, in the second assistance level, when the preceding vehicle is present, the inter-vehicle distance with respect to the preceding vehicle is controlled to be a predetermined second reference distance longer than the first reference distance. In addition, the steering actuator is controlled such that the vehicle 100 travels along the lane. Further, at the first assistance level and the second assistance level, a warning is issued to prompt the driver to visually recognize the front when the driver is not visually recognizing the front, and the driving assistance at the second assistance level is stopped when the driver is not visually recognizing the front even after the warning.

The third assistance level is an assistance level at which both acceleration and deceleration and steering of the vehicle 100 are performed automatically and the driver does not need to visually recognize the front, and corresponds to, for example, level 3 or higher of driving automation defined in SAE. Therefore, at the third assistance level, the internal combustion engine or the electric motor and the brake are controlled by the drive actuator and the brake actuator, and the steering is controlled by the steering actuator. In addition, at the third assistance level, the drive actuator and the braking actuator are controlled in the same manner as the first assistance level. However, in the third assistance level, when the preceding vehicle is present, the inter-vehicle distance with respect to the preceding vehicle is controlled to be a predetermined third reference distance longer than the second reference distance. In addition, the steering actuator is controlled such that the vehicle 100 travels along the lane. Further, in the third assistance level, since the driver does not need to visually recognize the front side, the warning or stop of the driving assistance is not performed even if the driver does not visually recognize the front side.

The ECU 30 controls the operation of the vehicle actuator 21 in executing the driving assistance. Further, the ECU 30 controls information to be provided from the information providing device of the HMI 15. Therefore, the ECU 30 controls the images displayed on the display 16 and the sound outputted from the speaker 17. As illustrated in FIG. 1, the ECU 30 includes a communication interface 31, a storage unit 32, and a processor 33.

The communication interface 31 is a circuit for connecting the ECU 30 to the in-vehicle network 25.

The storage unit 32 stores data. The storage unit 32 includes, for example, at least one of a volatile semiconductor memory, a nonvolatile semiconductor memory, a hard disk drive (HDD), and a solid state drive (SSD). The storage unit 32 stores a computer program executed by the processor 33 of the ECU 30. Further, the storage unit 32 stores data used in a computer program executed by the processor 33, such as data transmitted from the vehicle exterior camera 11 or the like. In addition, the storage unit 32 stores a high-definition map including information such as road information for each lane and surrounding structures information.

The processor 33 comprises one or more CPU (Central Processing Unit) and its peripheral circuitry. The processor 33 may further include other arithmetic circuits such as a logical arithmetic unit or a numerical value arithmetic unit. The processor 33 executes a computer program stored in the storage unit 32.

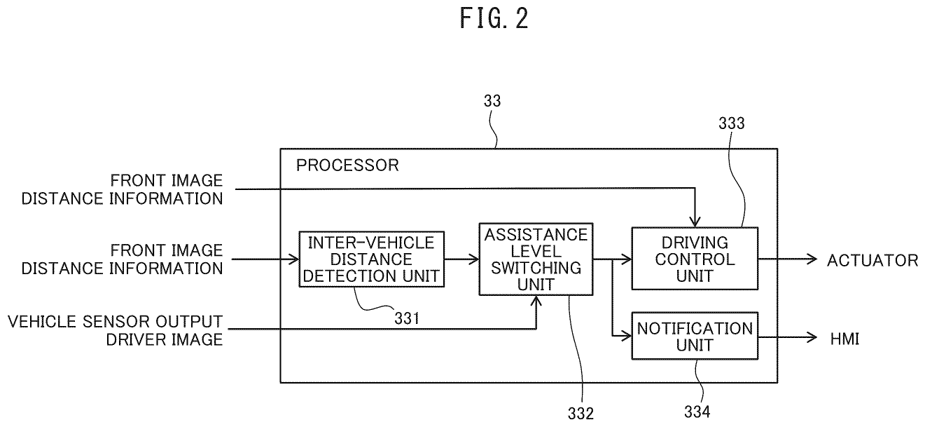

FIG. 2 is a functional diagram of the processor 33 of the ECU 30. As illustrated in FIG. 2, the processor 33 includes an inter-vehicle distance detection unit 331, a assistance level switching unit 332, a driving control unit 333, and a notification unit 334.

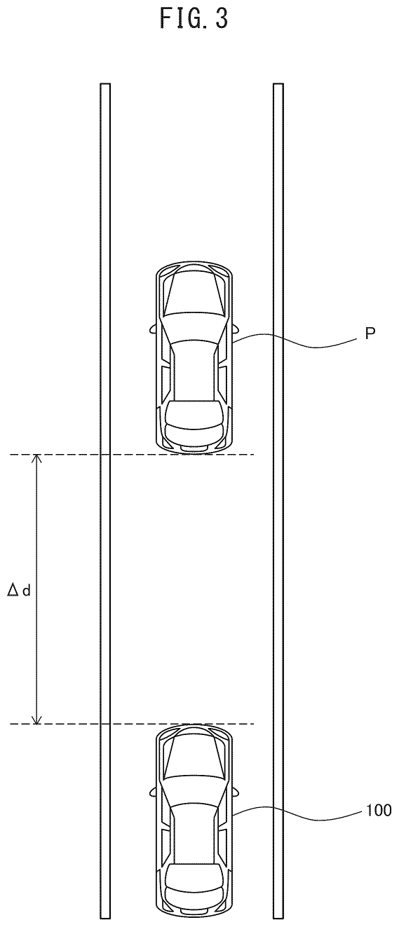

The inter-vehicle distance detection unit 331 detects an inter-vehicle distance between the vehicle 100 and a preceding vehicle traveling in the same lane as the vehicle 100 preceding the vehicle 100. FIG. 3 is a diagram illustrating a state of a vehicle traveling in one lane. In the example illustrated in FIG. 3, the preceding vehicle P travels immediately before the vehicle 100 in the same lane as the lane in which the vehicle 100 travels. The inter-vehicle distance detection unit 331 detects the inter-vehicle distance Ad between the preceding vehicle P and the vehicle 100.

The inter-vehicle distance detection unit 331 receives an image captured by the vehicle exterior camera 11 and distance information measured by the distance measuring sensor 12. The inter-vehicle distance detection unit 331 calculates an inter-vehicle distance between the vehicle 100 and the preceding vehicle P based on the input image and distance information. Specifically, for example, the inter-vehicle distance detection unit 331 recognizes the preceding vehicle P based on an image captured by the vehicle exterior camera 11. In addition, the inter-vehicle distance detection unit 331 calculates the inter-vehicle distance Ad between the vehicle 100 and the preceding vehicle P, based on the distance information measured by the distance measuring sensor 12 with respect to the recognized position (direction) of the preceding vehicle. The inter-vehicle distance detection unit 331 outputs the calculated inter-vehicle distance Ad between the vehicle 100 and the preceding vehicle P to the assistance level switching unit 332.

When a switching condition to an arbitrary assistance level is satisfied, the assistance level switching unit 332 switches the assistance level of the driving assistance device to the assistance level in which the switching condition is satisfied. The assistance level switching unit 332 receives the inter-vehicle distance Ad with the preceding vehicle P output from the inter-vehicle distance detection unit 331, the output of the driver monitor camera 13 (an image captured by the driver monitor camera 13), and the output of the vehicle sensor 14. Further, the assistance level switching unit 332 sets the assistance level in the driving assistance, and outputs the set assistance level to the driving control unit 333 and the notification unit 334.

In the present embodiment, the switching condition to the first assistance level includes that the inter-vehicle distance Ad with respect to the preceding vehicle P is equal to or greater than a first reference distance. Therefore, when it is required to switch the assistance level to the first assistance level, if the inter-vehicle distance Ad with the preceding vehicle P is less than the first reference distance, the switching to the first assistance level is not performed.

In addition, the switching condition to the first assistance level includes that the driver holds the steering wheel. The assistance level switching unit 332 determines whether or not the driver holds the steering wheel based on the output of the vehicle sensor 14, in particular, the output of the steering wheel gripping sensor. When it is required to switch the assistance level to the first assistance level, if it is determined that the driver does not hold the steering wheel, the switching to the first assistance level is not performed.

Further, the switching condition to the first assistance level includes that the driver is visually recognizing the front. The assistance level switching unit 332 determines whether or not the driver is visually recognizing the front based on the output of the driver monitor camera 13. For example, the assistance level switching unit 332 inputs an image acquired from the driver monitor camera 13 to a discriminator that recognizes the upper eyelid and the lower eyelid, and detects a distance between the recognized upper eyelid and the lower eyelid as the eye opening degree. Further, for example, the assistance level switching unit 332 inputs the image acquired from the driver monitor camera 13 to a discriminator trained in advance so as to specify the positions of the pupil and the corneal reflection of the light source. Then, the assistance level switching unit 332 detects the line-of-sight direction based on the positional relationship between the specified pupil and the corneal reflection. The assistance level switching unit 332 determines that the driver does not visually recognize the front, when the detected eye opening degree is less than a predetermined value and thus the driver closes the eye, or when the detected line-of-sight direction is not a forward direction. On the other hand, when the eye opening degree is equal to or greater than the predetermined value and the line-of-sight direction is a forward direction, the assistance level switching unit 332 determines that the driver is visually recognizing the front. When it is required to switch the assistance level to the first assistance level, if it is determined that the driver is not visually recognizing the front, the switching to the first assistance level is not performed.

In the present embodiment, the switching condition to the second assistance level includes that the inter-vehicle distance Ad with respect to the preceding vehicle P is equal to or greater than a second reference distance. The second reference distance is greater than the first reference distance. Therefore, when it is required to switch the assistance level to the second assistance level, if the inter-vehicle distance Ad with the preceding vehicle P is less than the second reference distance, the switching to the second assistance level is not performed.

In addition, the switching condition to the second assistance level includes that the driver is visually recognizing the front. Whether or not the driver is visually recognizing the front is determined based on the output of the driver monitor camera 13 as described above. When it is required to switch the assistance level to the second assistance level, if it is determined that the driver is not visually recognizing the front, the switching to the second assistance level is not performed. The switching condition to the second assistance level does not include that the driver holds the steering wheel.

In the present embodiment, the switching condition to the third assistance level includes that the inter-vehicle distance Ad with respect to the preceding vehicle P is equal to or greater than a third reference distance. The third reference distance is longer than the second reference distance. Therefore, when it is required to switch the assistance level to the third assistance level, if the inter-vehicle distance Ad with the preceding vehicle P is less than the third reference distance, the switching to the third assistance level is not performed.

In addition, the switching condition to the third assistance level includes that the position at which the vehicle 100 is traveling is included in the high-definition map stored in the storage unit 32. Here, since the high-definition map does not necessarily cover all the roads, the road on which the vehicle 100 is currently traveling may be a road that is not included in the high-definition map. For example, the assistance level switching unit 332 identifies the self position of the vehicle 100 based on the output of the vehicle sensor 14, in particular, the output of the self position sensor, and determines whether the identified self position is included in the high-definition map. When it is required to switch the assistance level to the third assistance level, if it is determined that the self position of the vehicle 100 is not included in the high-definition map, the switching to the third assistance level is not performed.

Further, the switching condition to the third assistance level may include that the speed of the vehicle 100 is equal to or less than the reference speed. The assistance level switching unit 332 determines whether or not the speed of the vehicle 100 is equal to or less than the reference speed, based on the output of the vehicle sensor 14, in particular, the output of the speed sensor. When switching of the assistance level to the third assistance level is required, if it is determined that the speed of the vehicle 100 is not equal to or lower than the reference speed, the switching to the third assistance level is not performed.

The above-described switching conditions to each assistance level are one example. Accordingly, the switching condition to each assistance level may include one or more other conditions in addition to or instead of the conditions described above. However, even in this case, it is necessary that the switching condition to each assistance level includes the condition regarding the inter-vehicle distance Ad with respect to the preceding vehicle P. In addition, it is necessary that the first reference distance in the switching condition to the first assistance level, the second reference distance in the switching condition to the second assistance level, and the third reference distance in the switching condition to the third assistance level become longer in this order.

The driving control unit 333 controls the driving of the vehicle 100. In particular, the driving control unit 333 controls the driving of the vehicle 100 at the assistance level set by the assistance level switching unit 332. The assistance level set by the assistance level switching unit 332 is input to the driving control unit 333. Further, information necessary for driving the vehicle 100, for example, an image captured by the vehicle exterior camera 11 and distance information measured by the distance measuring sensor 12 are input to the driving control unit 333.

For example, when the assistance level is set to the first assistance level, the driving control unit 333 controls the drive actuator and the braking actuator. In particular, when the preceding vehicle P is present at this time, the driving control unit 333 controls the drive actuator and the braking actuator so that the inter-vehicle distance Ad with respect to the preceding vehicle P becomes the first reference distance. When the assistance level is set to the second assistance level, the driving control unit 333 controls the drive actuator, the braking actuator, and the steering actuator. In particular, when the preceding vehicle P is present at this time, the driving control unit 333 controls the drive actuator and the braking actuator so that the inter-vehicle distance Ad with respect to the preceding vehicle P becomes the second reference distance. Further, when the assistance level is set to the third assistance level, the driving control unit 333 controls the drive actuator, the braking actuator, and the steering actuator. In particular, when the preceding vehicle P is present at this time, the driving control unit 333 controls the drive actuator and the braking actuator so that the inter-vehicle distance Ad with respect to the preceding vehicle P becomes the third reference distance.

In addition, when an assistance level which is being set (hereinafter, also referred to as “set assistance level”) and an assistance level requested by the driver (hereinafter, also referred to as “requested assistance level”) are different from each other, the driving control unit 333 controls the driving actuator and the braking actuator so that the inter-vehicle distance Ad between the preceding vehicle P and the preceding vehicle P becomes the reference distance corresponding to the requested assistance level. Therefore, for example, when the set assistance level is the first assistance level and the requested assistance level is the second assistance level, the driving control unit 333 controls the drive actuator and the braking actuator such that the inter-vehicle distance Ad with respect to the preceding vehicle P increases to the second reference distance. As a result, when the inter-vehicle distance Ad with the preceding vehicle P reaches the reference distance corresponding to the requested assistance level, the assistance level switching unit 332 determines that the switching condition to the requested assistance level (related to the inter-vehicle distance) is satisfied, and the set assistance level is switched.

As described above, since the first reference distance, the second reference distance, and the third reference distance become longer in this order, when an increase in the assistance level is requested when the vehicle 100 is being driven at the first assistance level or the second assistance level, the driving control unit 333 controls the driving of the vehicle 100 so that the inter-vehicle distance is increased. This makes it possible to increase the inter-vehicle distance in advance before the assistance level is changed.

The notification unit 334 notifies the driver of the switching of the assistance level when the assistance level of the vehicle 100 is switched. The notification unit 334 notifies the driver of the switching of the assistance level via the information providing device of the HMI 15. For example, the notification unit 334 causes the display 16 to display switching of the assistance level and the assistance level after switching. Alternatively, the notification unit 334 causes, for example, the speaker 17 to output sound representing the switching of the assistance level and the assistance level after the switching.

In the present embodiment, the switching condition to each assistance level includes that the inter-vehicle distance is equal to or greater than the reference distance, and the second reference distance in the switching condition to the second assistance level is longer than the first reference distance in the switching condition to the first assistance level. Here, in the second assistance level, the degree of contribution to the driving of the driver is lower than in the first assistance level, and therefore, a response of the driver is likely to be delayed in an emergency. According to the present embodiment, since the second reference distance is longer than the first reference distance, delay in response of the driver in an emergency when changing to the second assistance level is suppressed.

Further, in the present embodiment, the third reference distance in the switching condition to the third assistance level is longer than the second reference distance in the switching condition to the second assistance level. Here, in the third assistance level, the degree of contribution to the driving of the driver is lower than in the second assistance level, and therefore, a response of the driver is likely to be delayed in an emergency. According to the present embodiment, since the third reference distance is longer than the second reference distance, delay in response of the driver in an emergency when changing to the third assistance level is suppressed.

### <Specific Control>

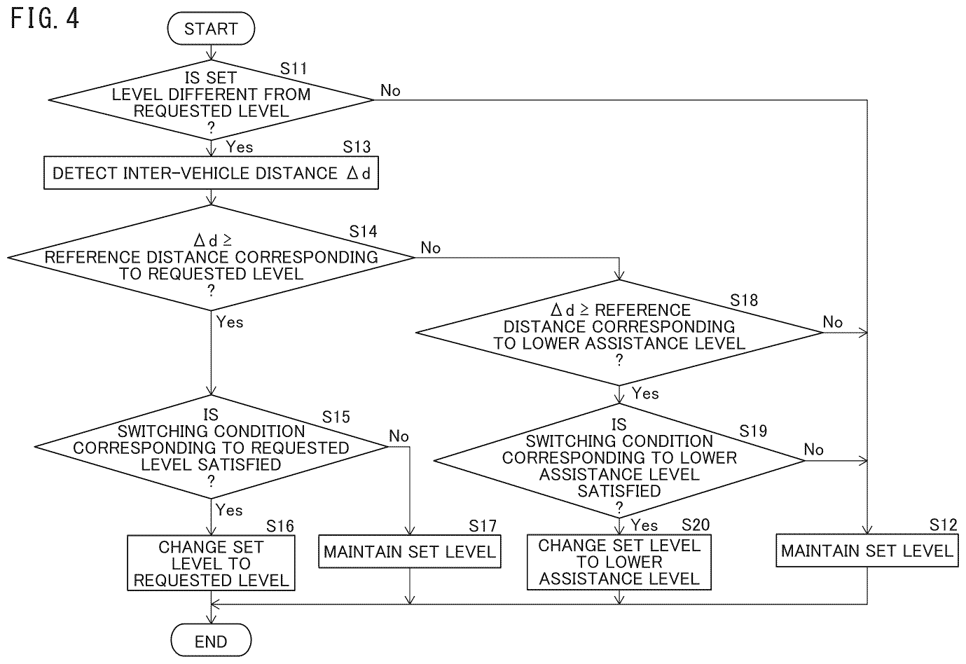

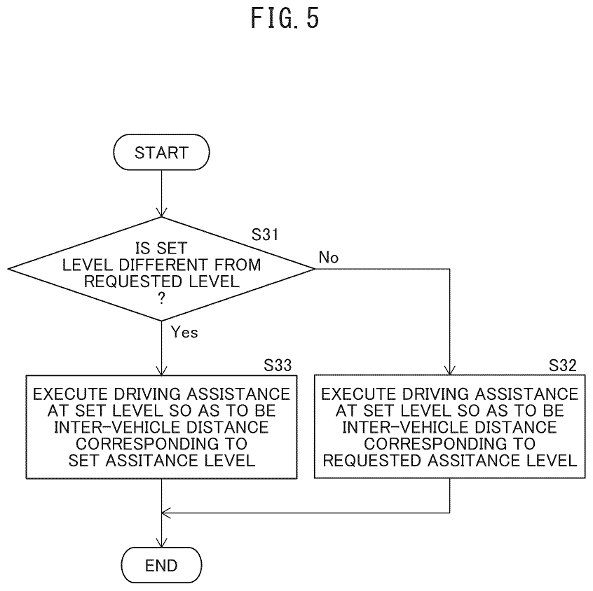

Next, a specific flow of control will be described with reference to FIGS. 4 and 5. FIG. 4 is a flowchart illustrating a flow of assistance level setting processing for setting a assistance level. The illustrated assistance level setting processing is executed by the processor 33.

As illustrated in FIG. 4, in the assistance level setting process, the assistance level switching unit 332 first determines whether or not the current set assistance level is different from the requested assistance level (step S11). The requested assistance level is input by the driver, for example, via an input device of the HMI 15, in particular the touch panel 18. For example, when the driver inputs one of the assistance levels from the first assistance level to the third assistance level as the request assistance level when the driving assistance is not performed, it is determined that the set assistance level and the requested assistance level are different from each other. Alternatively, for example, in a case where the third assistance level has been input as the requested assistance level, but the switching condition to the third assistance level is not satisfied so far and thus the assistance level is set to the first assistance level or the second assistance level, it is determined that the set assistance level and the requested assistance level are different from each other. When it is determined in step S11 that the set assistance level and the requested assistance level are not different from each other, the assistance level switching unit 332 maintains the current set assistance level (step S12).

On the other hand, when it is determined in step S11 that the set assistance level and the requested assistance level are different from each other, the inter-vehicle distance detecting unit 331 detects the inter-vehicle distance Ad between the vehicle 100 and the preceding vehicle P (step S13). Next, the assistance level switching unit 332 determines whether or not the inter-vehicle distance Δd detected by the inter-vehicle distance detecting unit 331 is equal to or greater than the reference distance corresponding to the requested assistance level (step S14). For example, when the requested assistance level is the second assistance level, the assistance level switching unit 332 determines whether the inter-vehicle distance Δd is equal to or greater than the second reference distance.

When it is determined in step S14 that the inter-vehicle distance Δd is equal to or greater than the reference distance corresponding to the requested assistance level, the assistance level switching 2.5 unit 332 determines whether or not the other switching condition corresponding to the requested assistance level is satisfied (step S15). For example, when the requested assistance level is the second assistance level, the assistance level switching unit 332 determines whether or not the driver is visually recognizing the front. When it is determined in step S15 that another switching condition corresponding to the requested assistance level is satisfied, the assistance level switching unit 332 sets the requested assistance level to a new assistance level (step S16). On the other hand, when it is determined in step S15 that the other switching condition corresponding to the requested assistance level is not satisfied, the assistance level switching unit 332 does not change the assistance level and maintains the present set assistance level (step S17).

When it is determined in step S14 that the inter-vehicle distance Δd is less than the reference distance corresponding to the requested assistance level, the assistance level switching unit 332 determines whether or not the inter-vehicle distance Δd is equal to or greater than the reference distance corresponding to the assistance level lower than the requested assistance level (step S18). Therefore, for example, when the requested assistance level is the second assistance level, the assistance level switching unit 332 determines whether or not the inter-vehicle distance Δd is equal to or greater than the first reference distance. Further, for example, when the requested assistance level is the third assistance level, the assistance level switching unit 332 determines whether or not the inter-vehicle distance Δd is equal to or greater than the first reference distance or the second reference distance. When it is determined in step S14 that the inter-vehicle distance Δd is less than the reference distance corresponding to the assistance level lower than the requested assistance level, the assistance level switching unit 332 does not change the assistance level and maintains the present set assistance level (step S12).

When it is determined in step S14 that the inter-vehicle distance Δd is equal to or greater than the reference distance corresponding to the assistance level lower than the requested assistance level, the assistance level switching unit 332 determines whether or not the other switching condition corresponding to the lower assistance level at which the inter-vehicle distance Δd was equal to or greater than the reference distance thereof, is satisfied (step S19). For example, when the lower assistance level at which the inter-vehicle distance Δd is equal to or greater than the reference distance is the first assistance level, the assistance level switching unit 332 determines whether or not the driver is holding the steering wheel and whether or not the driver is visually recognizing the front. When it is determined in step S19 that the other switching condition corresponding to the lower assistance level is satisfied, the assistance level switching unit 332 newly sets a assistance level to the lower assistance level (step S20). On the other hand, when it is determined in step S19 that the other switching condition corresponding to the lower assistance level is not satisfied, the assistance level switching unit 332 does not change the assistance level and maintains the present set assistance level (step S12).

By being controlled in this way, in the present embodiment, the assistance level switching unit 332 switches the assistance level to the third assistance level, in the case where the driving assistance at the third assistance level, which is the highest assistance level, is requested when the driving assistance is not being executed, if the inter-vehicle distance Δd is equal to or greater than the third reference distance. However, even in such a case, if the inter-vehicle distance Δd is less than the third reference distance and is equal to or greater than the second reference distance, the assistance level switching unit 332 switches the assistance level to the second assistance level. In addition, in such a case, if the inter-vehicle distance Δd is less than the second reference distance and is equal to or greater than the first reference distance, the assistance level switching unit 332 switches the assistance level to the first assistance level. Therefore, in the case where driving assistance at the highest assistance level is requested when driving assistance is not being executed, the assistance level switching unit 332 switches the assistance level to an assistance level that can be started based on the inter-vehicle distance. As a result, the driving assistance is performed at the highest possible assistance level.

FIG. 5 is a flowchart illustrating a flow of driving assistance processing for performing driving assistance based on the set assistance level. The illustrated driving assistance processing is executed by the processor 33.

As illustrated in FIG. 5, in the driving assistance processing, first, the driving control unit 333 determines whether or not the current set assistance level and the requested assistance level are different from each other, similarly to in step S11 (step S31). When it is determined in step S31 that the set assistance level and the requested assistance level are not different from each other, the driving control unit 333 executes the driving assistance at the current set assistance level so as to be the inter-vehicle distance corresponding to the current set assistance level (step S32). On the other hand, when it is determined in step S31 that the set assistance level and the requested assistance level are different from each other, the driving control unit 333 executes the driving assistance at the current set assistance level so as to be the inter-vehicle distance corresponding to the requested assistance level (step S33). Therefore, for example, when the requested assistance level is the second assistance level and the current set assistance level is the first assistance level, the driving control unit 333 controls the drive actuator and the braking actuator so that the inter-vehicle distance Δd becomes the first reference distance, and does not control the steering actuator.

In the above-described embodiment, the driving assistance device can execute driving assistance at three assistance levels: a first assistance level, a second assistance level, and a third assistance level. However, the driving assistance device may not be able to execute the driving assistance at the third assistance level as long as the driving assistance at the first assistance level and the second assistance level can be performed.

While preferred embodiments according to the present disclosure have been described above, the present disclosure is not limited to these embodiments, and various modifications and changes can be made within the scope of the claims.

1. A driving assistance device capable of executing driving assistance of a vehicle at a first assistance level and a second assistance level, which have different degrees of contribution to driving of a driver, comprising a processor, the processor being configured to:
detect an inter-vehicle distance between the vehicle and a preceding vehicle; and
when a switching condition to an arbitrary assistance level is satisfied, switch an assistance level in the driving assistance to an assistance level in which the switching condition is satisfied, wherein
the first assistance level is an assistance level at which acceleration and deceleration of the vehicle is automatically performed but steering of the vehicle is not automatically performed,
the second assistance level is an assistance level at which acceleration and deceleration and steering of the vehicle are automatically performed,
the switching condition to each assistance level includes that an inter-vehicle distance is equal to or greater than a reference distance, and
a reference distance in the switching condition to the second assistance level is longer than a reference distance in the switching condition to the first assistance level.

2. The driving assistance device according to claim 1, wherein
the vehicle can also perform driving assistance of the vehicle at a third assistance level, in addition to the first assistance level and the second assistance level,
in the second assistance level, the driver of the vehicle needs to visually recognize the front of the vehicle while the vehicle is automatically accelerated/decelerated and steered.
the third assistance level is an assistance level at which acceleration and deceleration and steering of the vehicle are automatically performed, while the driver of the vehicle does not required to visually recognize a front thereof, and
a reference distance in the switching condition to the third assistance level is longer than the reference distance in the switching condition to the second assistance level.

3. The driving assistance device according to claim 1, wherein
the processor is configured to control an operation of the vehicle, and
the processor is configured to control the driving of the vehicle so that the inter-vehicle distance becomes longer when an increase in the assistance level is requested when the vehicle is being driven in the first assistance level or the second assistance level.

4. The driving assistance device according to claim 1, wherein the processor is configured to switch the assistance level to an assistance level which can be started based on the inter-vehicle distance, when the driving assistance at the highest assistance level is requested when the driving assistance is not executed.

5. A driving assistance method for executing driving assistance of a vehicle at a first assistance level and a second assistance level, which have different degrees of contribution to driving of a driver, comprising:
detecting an inter-vehicle distance between the vehicle and the preceding vehicle; and
when a switching condition to an arbitrary assistance level is satisfied, switching an assistance level in the driving assistance to an assistance level in which the switching condition is satisfied, wherein
the first assistance level is a assistance level at which acceleration and deceleration of the vehicle is automatically performed but steering of the vehicle is not automatically performed,
the second assistance level is a assistance level at which acceleration and deceleration and steering of the vehicle are automatically performed,
the switching condition to each assistance level includes that an inter-vehicle distance is equal to or greater than a reference distance, and
a reference distance in a switching condition to the second assistance level is longer than a reference distance in the switching condition to the first assistance level.
